(19) United States
(12) Patent Application Publication
(10) Pub. No.: US 2020/0255321 A1
(43) Pub. Date: Aug. 13, 2020

(54) METHOD OF MANUFACTURING OPTICAL FIBER GLASS BASE MATERIAL

(71) Applicant: SHIN-ETSU CHEMICAL CO., LTD., Tokyo (JP)

(72) Inventor: Yuhei URATA, Ibaraki-ken (JP)

(73) Assignee: SHIN-ETSU CHEMICAL CO., LTD., Tokyo (JP)

(21) Appl. No.: 16/788,603

(22) Filed: Feb. 12, 2020

(30) Foreign Application Priority Data
Feb. 13, 2019 (JP) 2019-023188

(51) Int. Cl. C03B 37/014

(52) U.S. Cl. CPC C03B 37/01406

(57) ABSTRACT

A method of manufacturing an optical fiber glass base material includes storing a glass particulate deposit prepared through a vapor-phase axial deposition (VAD) method in a storage chamber, wherein a hydrogen chloride concentration in the storage chamber is maintained at 2 ppm or lower, and a humidity in the storage chamber is preferably maintained at 12 g/m³ or lower. The storage chamber has an air supply port and an exhaust port, and a gas discharged from the exhaust port is re-supplied from the supply port into the storage chamber using a blower fan. A chemical filter is provided between the exhaust port and the blower fan. A dehumidifier is preferably provided between the exhaust port and the blower fan.

### TECHNICAL FIELD

The present invention relates to a method of manufacturing an optical fiber glass base material used for making an optical fiber by drawing.

### BACKGROUND ART

One of important characteristics of an optical fiber is a low transmission loss. Various types of dopant are incorporated into synthetic quartz as a base material in order to provide a refractive index distribution along a radial direction of the optical fiber. In this case, the dopant is required not to serve as a significant transmission loss factor by itself while changing the refractive index.

In manufacturing of the optical fiber base material in the vapor-phase axial deposition (VAD) method, silicon tetrachloride and germanium tetrachloride as a glass material are supplied to oxyhydrogen flame to produce silicon dioxide and germanium dioxide, and they are then deposited on a start material to obtain a glass particulate deposit.

In this case, the glass particulate deposit prepared through the VAD method contains moisture, which is regarded as a factor of increasing the transmission loss of the optical fiber. For this reason, dehydration is performed by heating the glass particulate deposit under an atmosphere including a chlorine-based gas as a part of a sintering process for transparent vitrification. In addition, before the transparent vitrification, a foreign object such as metal microparticles floating in the atmosphere may be unintentionally adhered to or mixed with the glass particulate deposit. Such a foreign object contained in the atmosphere also increases the transmission loss of the optical fiber obtained through transparent vitrification and drawing.

In order to prevent such a foreign object in the atmosphere from being unintentionally mixed with the glass particulate deposit, there is known a technique of preventing a foreign object from being adhered to the glass particulate deposit by storing the manufactured glass particulate deposit in a storage chamber (isolated room) into which a clean gas having less dust is introduced until the next sintering process (see Patent Document 1).

### CITATION LIST

### Patent Documents

Patent Document 1: Japanese Unexamined Patent Application Publication No.

### SUMMARY OF INVENTION

The glass particulate deposit prepared through the VAD method contains hydrogen chloride produced from a reaction between the oxyhydrogen flame and the silicon tetrachloride or germanium tetrachloride during the manufacturing. When such a glass particulate deposit is stored in the storage chamber, hydrogen chloride is discharged from the deposit into the storage chamber. As a result, a structure, a piping material, or the like in the storage chamber may be corroded, and a foreign object such as rust generated from the corrosion may float in the atmosphere in the storage chamber. Such a foreign object may contaminate the glass particulate deposit.

In order to store a glass particulate deposit having a large size and a weight of 10 kg or more, the storage chamber is to have a strong and sturdy metallic structure. However, when the structure in the storage chamber is corroded, and rust is generated, the rust may float in the atmosphere in the storage chamber, and may be mixed with or adhered to the glass particulate deposit in some cases. In addition, even when a clean gas circulating in a clean storage chamber is introduced as a gas in the storage chamber, it was difficult to prevent the foreign object generated in the storage chamber.

Even when the unintended metallic impurity is mixed in the storage chamber, it may be removed through the sintering process. However, when a large amount of metal is adhered, it was difficult to perfectly remove it. As a result, the transmission loss of the optical fiber may increase disadvantageously.

An object of the present invention is to provide a method of manufacturing an optical fiber glass base material, capable of preventing a foreign object such as a metallic impurity from being adhered to or mixed with a glass particulate deposit during storing in the storage chamber and obtaining an optical fiber having a low transmission loss.

In order to address such a problem, according to the present invention, there is provided a method of manufacturing an optical fiber glass base material. The method includes storing a glass particulate deposit prepared through a vapor-phase axial deposition (VAD) method in a storage chamber. A hydrogen chloride concentration in the storage chamber is maintained at 2 ppm or lower, and a humidity in the storage chamber is preferred to be maintained at 12 g/m³ or lower.

The storage chamber has an air supply port and an exhaust port, and a gas discharged from the exhaust port is re-supplied from the supply port into the storage chamber using a blower fan.

Preferably, a chemical filter is provided between the exhaust port and the blower fan, and a dehumidifier is provided between the exhaust port and the blower fan.

According to the present invention, it is possible to provide a method of manufacturing an optical fiber glass base material, capable of preventing a foreign object such as rust generated from corrosion of the metallic structure from being adhered to or mixed with a glass particulate deposit during storing in the storage chamber and suppressing contamination of the optical fiber glass base material.

### BRIEF DESCRIPTION OF DRAWINGS

FIG. 1 is a schematic diagram illustrating an exemplary configuration of a glass particulate deposit storage chamber according to the present invention; and

FIG. 2 is a schematic diagram illustrating a configuration of a glass particulate deposit storage chamber in a comparative example.

### DESCRIPTION OF EMBODIMENTS

Hereinafter, embodiments of the present invention will be described in details with reference to the accompanying drawings by explaining an example of the present invention and a comparative example. However, the invention is not limited thereto, and various modes may be possible.

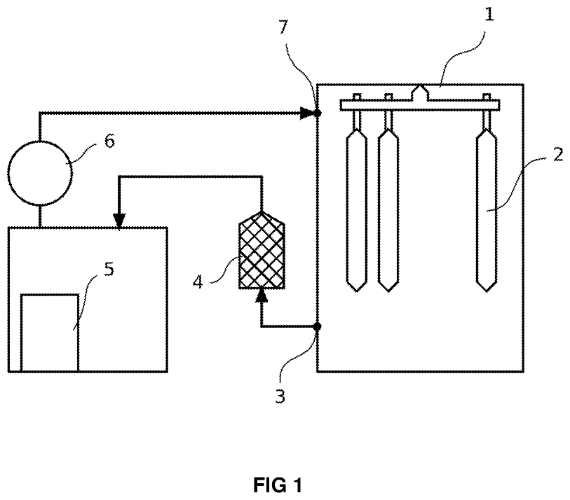

FIG. 1 is a schematic diagram illustrating an exemplary configuration of a glass particulate deposit storage chamber according to the present invention.

As illustrated in FIG. 1, a manufactured glass particulate deposit 2 is stored in a storage chamber 1 isolated from the outside. The storage chamber 1 has an exhaust port 3 to discharge the air of the storage space. A gas discharged from the exhaust port 3 passes through a chemical filter 4 arranged in the downstream. The chemical filter 4 is formed from a filter medium based on activated carbon, and adsorbs or removes an acidic gas (hydrogen chloride). A dehumidifier 5 is provided in the downstream of the chemical filter 4 to remove moisture in the air. The dehumidifier 5 compresses a refrigerant using a compressor, and condenses and removes (dehumidifies) moisture in the air using latent heat generated in evaporation of the refrigerant. As a result, a hydrogen chloride gas is removed from the air discharged from the exhaust port, and the air is dried. Then, the treated air is re-supplied from the supply port 7 to the storage chamber 1 using the blower fan 6.

### EXAMPLES

A glass particulate deposit 2 prepared through the VAD method was stored in a storage chamber 1 illustrated in FIG. 1. During the storing, the air inside the storage space was discharged from the exhaust port 3 and was filtered through a chemical filter 4 provided in the downstream thereof to absorb or remove an acidic gas (hydrogen chloride). Furthermore, moisture was removed using the dehumidifier 5 provided in the downstream thereof, and the treated gas was returned from the supply port 7 to the storage chamber 1 using the blower fan 6. As a result, a hydrogen chloride gas concentration in the storage chamber was maintained at 2 ppm or lower, and a humidity in the storage chamber was maintained at 12 g/m³ or lower.

Then, the glass particulate deposit 2 was stored in the storage chamber for 24 hours and was then introduced into a furnace core tube formed of quartz glass. The internal space of the furnace core tube was maintained in an atmosphere including a chlorine gas of 2.7%. The glass particulate deposit 2 was heated in the heating furnace at a temperature of 1150° C. for dehydration. Then, the furnace core tube was maintained in a helium atmosphere, and the glass particulate deposit 2 was heated in the heating furnace at a temperature of 1500° C. for transparent vitrification. As a result, a transparent glass core base material was manufactured.

An optical fiber glass base material was prepared by externally attaching a glass cladding layer around the resulting transparent glass core base material, and was drawn to obtain an optical fiber. The transmission characteristics of the manufactured optical fiber were measured. It was found that a single-mode optical fiber having excellent optical characteristics as shown in Table 1 was obtained.

TABLE 1

| | | | Exam- | Exam- | Exam- |
|---|---|---|---|---|---|
| | | | ple 1 | ple 2 | ple 3 |
| Transmission | 1310 nm | [dB/km] | 0.326 | 0.324 | 0.325 |
| loss | 1383 nm | [dB/km] | 0.282 | 0.279 | 0.279 |
| | 1550 nm | [dB/km] | 0.184 | 0.185 | 0.184 |
| Mode field | 1310 nm | [μm] | 9.22 | 9.26 | 9.26 |
| diameter | | | | | |

| | | | | |
|---|---|---|---|---|
| Cut-off wavelength (2 m- | [nm] | 1266 | 1265 | 1268 |
| length fiber) | | | | |
| Zero-dispersion wavelength | [nm] | 1311.2 | 1312.3 | 1312.0 |

### Comparative Example

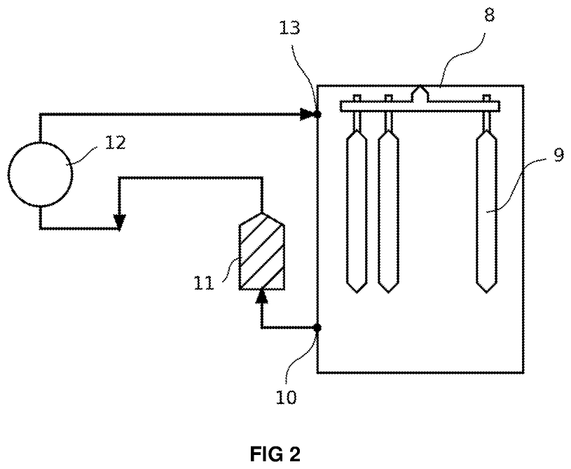

A glass particulate deposit 9 prepared through the VAD method was stored in a storage chamber 8 illustrated in FIG. 2. During the storing, the air inside the storage space was discharged from the exhaust port 10, and was filtered through a HEPA filter 11 provided in the downstream thereof to remove dust in a gas. The gas filtered through the HEPA filter 11 was classified to Class 10000, and was returned from the supply port 13 to the storage chamber 8 again using the blower fan 12. Note that the HEPA filter is an “air filter having a particle collection rate of 99.97% or higher for particles having a particle diameter of 0.3 μm at a rated flow rate and an initial pressure loss of 245 Pa (25 mm H₂O) or less” as specified in the standard JIS Z 8122:2000.

After the glass particulate deposit 9 was stored in the storage chamber 8 for 24 hours in this manner, a transparent glass core base material was prepared in the same sequence as that of the Example. An optical fiber glass base material was prepared by externally attaching a glass cladding layer around the transparent glass core base material obtained in this manner, and was drawn to obtain an optical fiber. The transmission characteristics of the manufactured optical fiber were measured. It was found that a single-mode optical fiber having the optical characteristics as shown in Table 2 was obtained.

Comparing with the Example, the transmission loss at 1310 nm and 1550 nm was higher by approximately 0.01 dB/km. In particular, the transmission loss at 1383 nm based on the OH group was higher by approximately 0.025 dB/km.

TABLE 2

| | | | Comparative example |
|---|---|---|---|
| Transmission loss | 1310 nm | [dB/km] | 0.336 |
| | 1383 nm | [dB/km] | 0.306 |
| | 1550 nm | [dB/km] | 0.195 |
| Mode field diameter | 1310 nm | [μm] | 9.04 |

| | | |
|---|---|---|
| Cut-off wavelength (2 m-length fiber) | [nm] | 1262 |
| Zero-dispersion wavelength | [nm] | 1321 |

### REFERENCE SIGNS LIST

1, 8 storage chamber,
2, 9 glass particulate deposit,
3, 10 exhaust port,
4 chemical filter,
5 dehumidifier,
6, 12 blower fan,
7, 13 supply port,
11 HEPA filter

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Japanese application No. 2019-023188, filed Feb. 13, 2019, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method of manufacturing an optical fiber glass base material, comprising
storing a glass particulate deposit prepared through a vapor-phase axial deposition (VAD) method in a storage chamber,
wherein a hydrogen chloride concentration in the storage chamber is maintained at 2 ppm or lower.

2. The method according to claim 1, wherein
a humidity in the storage chamber is maintained at 12 g/m³ or lower.

3. The method according to claim 1, wherein
the storage chamber has an air supply port and an exhaust port, and
a gas discharged from the exhaust port is re-supplied from the supply port into the storage chamber using a blower fan.

4. The method according to claim 3, wherein
a chemical filter is provided between the exhaust port and the blower fan.

5. The method according to claim 3, wherein
a dehumidifier is provided between the exhaust port and the blower fan.
